(19) United States
(12) Patent Application Publication
(10) Pub. No.: US 2012/0218283 A1
(43) Pub. Date: Aug. 30, 2012

(54) Method for Obtaining Brighter Images from an LED Projector

(75) Inventor: Takatoshi Ishii, Sunnyvale, CA (US)

(73) Assignee: SPATIAL PHOTONICS, INC., Sunnyvale, CA (US)

(21) Appl. No.: 13/037,078

(22) Filed: Feb. 28, 2011

(51) Int. Cl. G09G 5/02

(52) U.S. Cl. 345/589

(57) ABSTRACT

A method for improving brightness of projected images from an LED projector employing a plurality of LEDs of different colors by determining, from a histogram of a frame of an image to be projected, an effective maximum saturation. A plurality of main channels and a plurality of subchannels are created, one main channel and at least one subchannel for each color LED. Then the amplitude of the main channel and a subchannel for each color are determined based upon the effective maximum saturation of the frame of the image, followed by using the main channel and the at least one subchannel for a color to drive an LED of that color to generate the image.

### TECHNICAL FIELD

This invention relates to the field of LED digital projectors, and more particularly to adaptive techniques for improving the brightness of projected images from those projectors.

### BACKGROUND

Table top and ceiling digital projectors, such as those used in businesses, have been around for a long time. Over time, their size has been reduced and their projected images have gotten brighter. Until recently, most such projectors used UHP (Ultra High Performance) lamps as their source of illumination, but now many projectors are employing LEDs as their light source.

The digital image projected by these projectors is produced by passing the light from the LEDs through a spatial light modulator (SLM). Two types of SLMs are LCOS, using liquid crystal technology, and micromirror devices, using tiny mirrors formed on a silicon substrate along with the digital control electronics. Typically, micromirror devices have one mirror for each pixel to be projected. A micromirror array works with three LEDs, one for each color, in a time sequence. The three primary colors, Red (R), Green (G) and Blue (B), are controlled in a time sequence to display of each pixel.

The three most important attributes of a projected image are brightness, contrast and saturation. A brighter image can be seen in a well lighted room. Contrast emphasizes the details in an image. Saturation determines how vividly the colors appear. In an LED projector, overlapping the three primary colors to some extent leaves the LEDs on for a longer period of time, thereby increasing brightness. However, this overlapping decreases the ability to display a pure red, green or blue color, thereby making it difficult or impossible to reproduce a fully saturated image. Too much of a drop in saturation results in an image being washed out. The best projectors are capable of displaying a bright and clear image, even when the image is fully saturated.

### SUMMARY

A method for improving brightness of projected images from an LED projector employing a plurality of LEDs of different colors is described. The method starts by determining, from a histogram of a frame of an image to be projected, an effective maximum saturation. Then a plurality of main channels and a plurality of subchannels are created, one main channel and at least one subchannel for each color LED. Next the amplitude of the main channel and a subchannel for each color is determined based upon the effective maximum saturation of the frame of the image. Then the main channel for a color and the one subchannel for the color are used to drive an LED of that color to generate an image.

In another aspect, an effective maximum saturation of a pixel from a frame of an image to be projected is determined from the saturation values of each of the pixel's color components. The saturation values of the pixels of the frame are grouped according to the number of pixels having saturation values within a range of saturation values determined for the group. Then a threshold maximum saturation value (effective maximum saturation value) is established. Next the saturation values of pixels having saturation values below the effective maximum saturation value are boosted by an empirically determined multiple, thereby reducing washout that may be caused by driving the subchannel with the overlapped current used to drive an LED of that color. Finally, the pixels with boosted saturation values for each color are projected on the screen for generating the image.

In another aspect, the maximum component value is determined from a plurality of component values for the colors making up each pixel of the frame of pixels. Each of the plurality of component values may be calculated by subtracting the component value of a color making up a pixel that has the smallest saturation value of the colors making up the pixel from the component value of a color making up the pixel that has the largest component value of the colors making up the pixel.

The plurality of saturation values may be grouped and a cut off or threshold saturation value may be determined. The pixels that above the threshold value may be truncated.

The saturation values of pixels having saturation values below an effective maximum saturation value may be boosted. The saturation values of the pixels can be boosted by an empirically determined amount, where that amount may be determined based upon testing many images and determining the amount of boost that gives the best results. Each of the color components making up a pixel can be boosted and the maximum color component, a minimum color component and a color component in between the maximum and minimum color component that make up a pixel may be boosted differently to obtain a saturation boost for the pixel.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a system of an embodiment of the invention;

FIG. 2 is a block diagram of a content adaptive block and light source controller of an embodiment of the invention;

FIG. 3 is a block diagram of a light source controller of an embodiment of the invention;

FIG. 4 is a block diagram of a LED drive controller of an embodiment of the invention;

FIG. 5 is an example table used to select saturation values for an embodiment of the invention;

FIG. 6 is an example table of LED drive current settings corresponding to saturation values for an embodiment of the invention;

FIG. 7 is a graph of red, green and blue LED drive currents over time for an embodiment of the invention; and

FIG. 8 is an example table of empirically determined saturation multipliers used in an embodiment of the invention.

Like reference symbols in the various drawings indicate like elements.

### DETAILED DESCRIPTION

The content adaptive method of improving image brightness described here provides a substantial increase in brightness while minimizing the visual impact of saturation loss. Briefly, content adaptive brightness control uses an algorithm to create histograms for adjusting color saturation and brightness values of incoming image data frame by frame. The method adjusts the overlap amount of the three LED light sources depending upon maximum saturation/brightness histogram values. Where the maximum saturation value is low, the overlap amount may be increased, thus making the light source brighter. However, increasing the overlap amount narrows the gamut triangle for the image. A narrowed gamut triangle decreases image saturation, and may cause display screen colors to be washed out. The disclosed method modifies the display data to boost brightness and saturation, compensate the screen color, but still avoid saturation decreases sufficient to wash out the image.

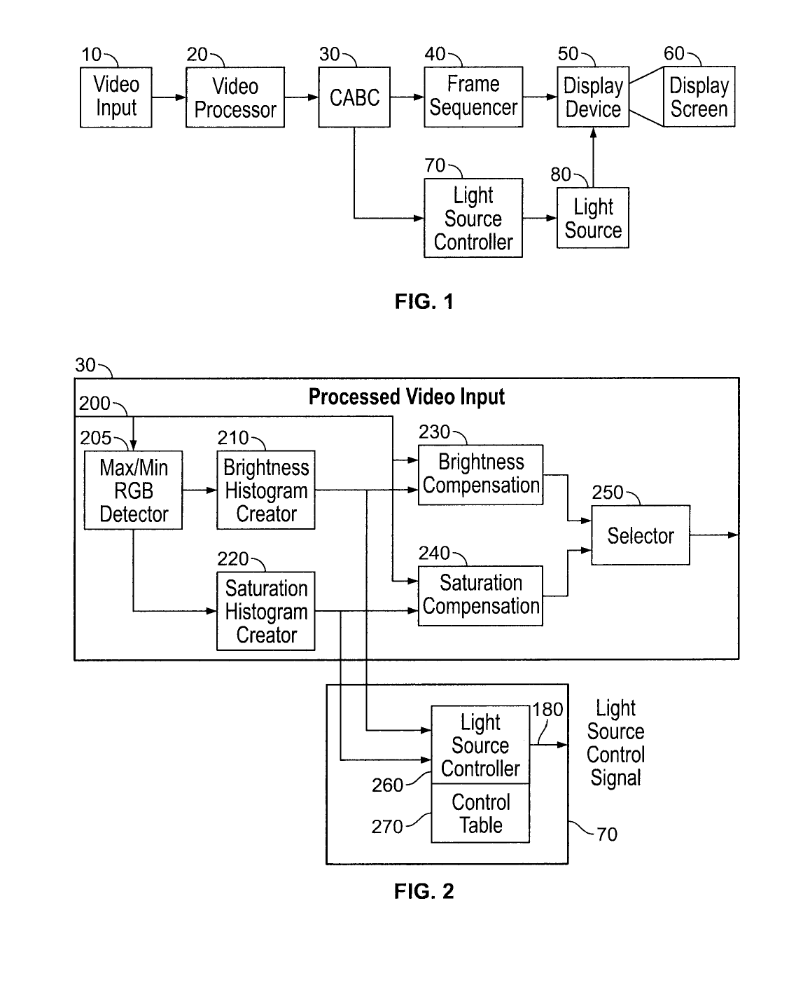

The system of an embodiment of the invention is shown in FIG. 1. The video input source 10 may be a personal computer, tablet, cell phone or other digital device that provides images. The images are passed to a conventional video processor, as is well known in the art, outputting the pixels of the image in multiple colors, frame by frame. Various color spaces or components may be used, such as RGB, CMYK or other color systems to create the image. An embodiment of this invention will be described using RGB color space (or RGB color components).

The video processor passes the image to a content adaptive brightness controller (CABC) 30, which will be described in detail below. From the CABC, the image is passed to a frame sequencer 40 to produce the frames, and then to a display device 50, such as a digital projector, that projects the image onto a display screen 60.

CABC 30 also passes control signals to a light source controller 70 to control the timing and current of the light sources being switched on and off. To create a brighter image, the timing causes the light sources, such as the LEDs in example to be described in detail below, to remain on longer, and also for one color LED to remain on while another color also is on, thus creating light source overlap. The output signals from light source controller 70 are passed to the light sources 80, such as LEDs, to turn them on at the desired times and currents, and the light sources pass their light to imaging surfaces, such as lenses in display device 50, and then on to the display screen 60.

The CABC is shown in more detail in FIG. 2. The processed video input 200 from video processor 20 comes into the CABC 30. Each frame of an image first goes to a max/min RGB detector 205, where the maximum, minimum and middle RGB values of the pixels of each respective color of a frame of an image are determined. From the max/min RGB detector 205, the maximum, minimum and middle values are passed to a brightness histogram creator 210 and a saturation histogram creator 220. The operation of these will be described below. The outputs of these histogram creators are used to determined brightness compensation in brightness and saturation compensation units 230 and 240, respectively. Both of these compensation units also receive the processed video input signal. The outputs from the brightness and saturation compensation units 230 and 240, respectively, are passed by selector 250 to frame sequencer 40 and display device 50 (FIG. 1) for display on screen 60.

The outputs from the brightness and saturation histogram creators 210 and 220 are also passed to light source controller 260. The light source controller 260 uses a control table 270, in a manner to be described below, to generate a light source control signal 180. This signal is passed by light source controller 70 to light source 80 (FIG. 1).

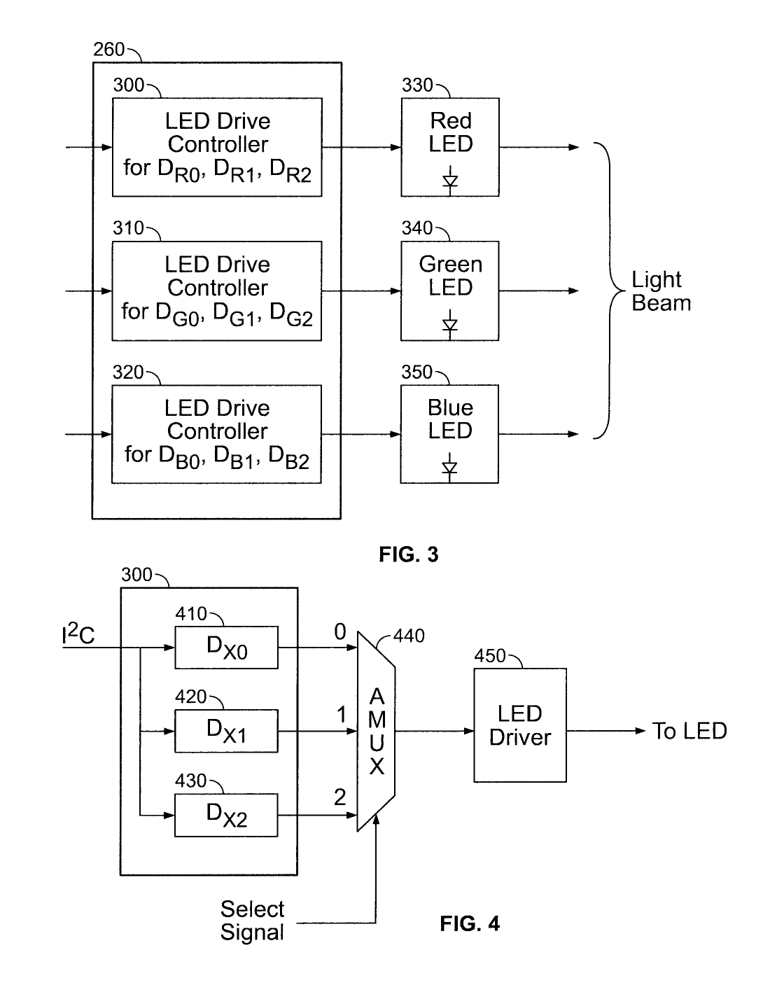

Light source controller 260 is shown in more detail in FIG. 3. It comprises three LED drive controllers, one for driving each color LED. LED drive controller 300 provides the red drive signals D_{R0}, D_{R1}, D_{R2} to red LED 330. Controller 310 provides the green drive signals D_{G0}, D_{G1}, D_{G2} to green LED 340. LED drive controller 320 provides the blue drive signals D_{B0}, D_{B1}, D_{B2} to blue LED 350.

One of the three LED drive controllers, controller 300 (FIG. 3), is shown in more detail in FIG. 4. “Dₓ₀” 410 is one of three drive controllers for one of the red, green or blue LEDs (“x” being generic to the three colors). Dₓ₁ is a second drive controller 420 for the same one of the red, green or blue LEDs, and Dₓ₂ is a third drive controller 430 for the same one of the red, green or blue LEDs. The three drive currents from the three drive controllers 410, 420 and 430 are fed to an AMUX (analog multiplexer) 440, where they are multiplexed and passed to LED driver 450 for driving the LED of that color. There are two additional drive controllers, not shown, each with an AMUX, for driving the LEDs of the other two colors.

The content adaptive brightness adjustment method starts with a frame of an image made up of pixels. In this embodiment, the pixels are three color components: red, green and blue. It is understood that other color schemes could be employed, for example CMYK. Assuming that the image contains a standard 1280×800 pixels (although any other size or aspect ratio image and pixel density may be used), there will be a total of 1,024,000 pixels, and each pixel has a red, a blue and a green color component value. For example, assume there is a pixel A with a red value R=250; a green value G=200 and a blue value B=150. Also, assume the total range of color component values is 0-255 (although smaller or much larger ranges can be used, such as a maximum of 1024, 2048 or many higher values).

A process to determine preferred color saturation for each pixel of each color is now commenced. One such process starts by calculating a saturation value “SatVal” for each pixel is determined by the equation: SatVal=MaxVal−MinVal. In the above example for pixel A, the largest color component value (MaxVal) is the value of the red pixel of 250, and the smallest (MinVal) is the value of the blue pixel of 150. Therefore SatVal=MaxVal (250)−MinVal (150)=100. The middle value, MdlVal, is the green value of 200.

The above calculation for saturation is executed in RGB color space, for example. Other color spaces (YIQ, YUV, YCrCb, HVS, or HVI) and color components can be used, but they will require different equations that one of ordinary skill may calculate using the principles described herein for RGB color space. For example, RGB color space can be translated to YUV (or YIQ) color space using matrix multiplication, where Y represents the amplitude modulated black and white information, and UV (or IQ) represents the color information in polar coordinates. UV and IQ are two different standards. They have the same color information, but the polar axes are phase shifted. Color saturation is the magnitude of the UV (or IQ) vector, and hue (or color tint) is the angle. In the UV and IQ standards, respectively, the equation for color saturation is SQRT(Û2+V̂2) or SQRT(Î2+Q̂2). The calculation in RGB color space is the simplest and best for real time applications.

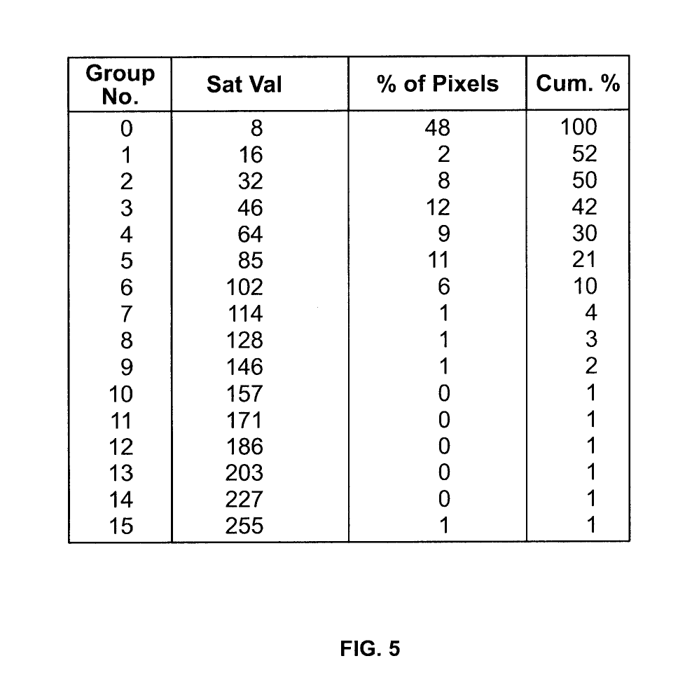

Next it is necessary to empirically determine a set of saturation ranges. These can be established from gamut diagrams. The ranges are grouped by group numbers listed in the first column of the table of FIG. 5. The upper border values of the group are listed in the second column labeled “Sat Val”. The actual saturation values for each pixel (SatVal), calculated as above, can be fitted in the group between one group's border value to the border value of the next adjacent group. For pixel A being discussed, having a calculated SatVal of 100, that SatVal is <=102 (the upper limit for Group No. 6), so it falls into Group 6. The same calculation is made for the SatVal of each of the 1,024,000 pixels of each frame.

Note in the third column entitled “% of Pixels,” that there is a 6 in the row for Group 6. That “6” indicates that 6%, or approximately 61,440 of the 1,024,000 pixels in the frame had a SatVal that fell into Group 6 (SatVals between 102-85). In the same table of FIG. 5, 1% of the 1,024,000 pixels had SatVals that fell in each of the ranges 255-228 (Group 15), 129-146 (Group 9), 115-128 (Group 8), and 103-114 (Group 7). Similarly, there were 48, 2, 8, 12, 9, 11 and 6% of the pixels, respectively, that fell into Groups 0, 1, 2, 3, 4, 5 and 6.

The fourth column of the table in FIG. 5, entitled “Cum %,” shows the cumulative percentage of pixels that fall into each of the Groups, counting from the bottom of the table. Therefore, 1% of the pixels fell into the bottom Group 15. Since there were no pixels in Groups 14, 13, 12, 11 and 10, the cumulative % of pixels in Groups 15-10 also is 1%. As 1% of the pixels fell into Group 9, the cumulative % of pixels in groups 15-9 (shown in the row of Group 9) is 2%. As the table covers 100% of the pixels in the frame, it follows that the cumulative % shown for all sixteen Groups (in the Cum % column of the first Group 0 row) as 100%.

The next step in the process is to determine a threshold SatVal. Referring to the “Cum %” column of the table of FIG. 5, we see that only 4% of the pixels of the frame under consideration fall into Group 7 to Group 15. Accordingly, if we select a cut off number to be 5%, then our threshold SatVal is selected to be 102 (the upper border value in Group 6), there will be ample pixels for 96% of the pixels of the frame.

In selecting the threshold SatVal, viewing preferences may be used. For example, if the image to be displayed requires maximum saturation (such as for a movie), the cut off value can be selected lower and threshold value can be selected higher in the table, such as a cutoff value of 1% in a manner so that Groups 0-9 are included, thereby having sufficient available pixels for 99% of the pixels. On the other hand, if the displayed image is a Powerpoint slide, where saturation is less important, the cutoff value is 12% and a threshold may be selected to include only Groups 0-5, whereby the available pixels still will be sufficient to display 90% of the pixels.

There are numerous ways to choose the best threshold SatVal, either manually or by using an algorithm, or some combination. For example, if the image content changes from frame to frame, the images are mostly likely video. If the image is static for significant periods of time, then most likely a Powerpoint or other slide show is being projected. Using image processing, it often is possible to detect the difference between a slide show of pictures from one of Powerpoint slides. From this, a preferred threshold SatVal can be chosen, preferably one that has a lower pixel cutoff for video pictures, and a higher cutoff for a Powerpoint presentation. Within these groups, user preferences may be taken into consideration in selecting the threshold SatVal.

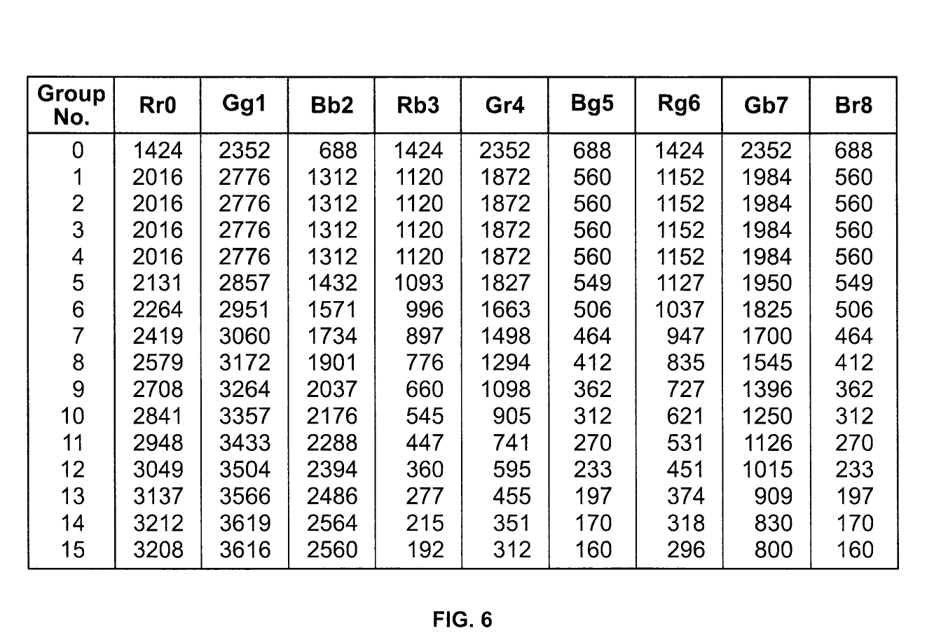

Referring to FIG. 6, in our example where we cut off the SatVals above Group 6, we use the drive current values in FIG. 6 in the row Group 6 in the first column. The exact drive current values employed depend upon the DAC being used to generate the drive currents. In the example of FIG. 6, the maximum drive current is 4095. Therefore the value of Rr0 in Group 6 (2264) means that 2264/4095 of the maximum red LED drive current will be used to drive the red LED when the red data is being displayed. The term “Rr0” has three components: capital “R” signifies the red LED; small “r” means that during this time period, red video data is being displayed (as opposed to green or blue data); and the“0” indicates that this is the first of nine values of channel numbers.

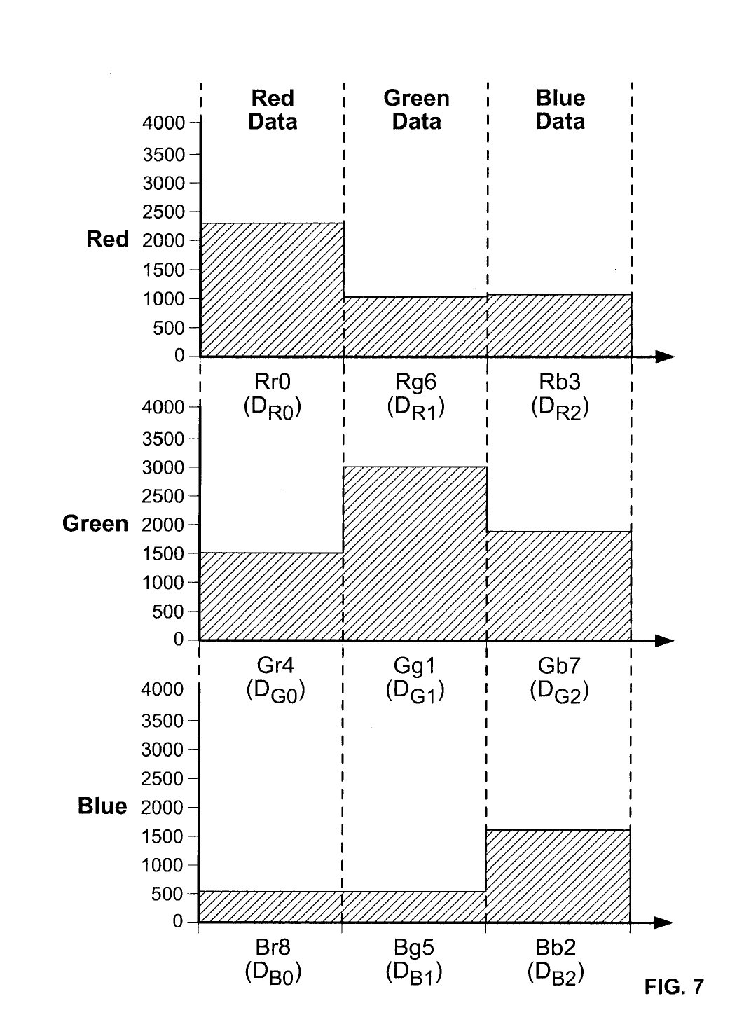

Referring to FIG. 7, the upper graph is labeled “RED” and shows the drive currents for the red LED. The first time period in each graph, as shown by the captions at the top, displays the time period during which “red data” is being displayed. This “red data” comes from the image and is based upon the intensity of the red color in the image to be displayed during that time period. Similarly, the second time period is when green data is being displayed, and the third time period is when blue data is being displayed.

Referring to FIGS. 6 and 7, using Group 6 as the example, the first Rr0 value shown in the first graph (“Rr0” indicates the RED (R) LED, red data (r) and the 0^{th} value out of nine) is 2264, indicating that the RED LED drive current is 2264/4095 of the maximum drive current value during the red data time period. Similarly, in the second graph labeled “GREEN” for the GREEN LED, the Gg1 value of 2951, during the time which green data is being displayed, means that the GREEN LED drive current from the table of FIG. 6 is 2951 (2951/4095); and finally the value Bb2 of the drive current for the BLUE LED during the blue data time period is 1571 (1571/4095).

In accordance with the invention described in U.S. patent application Ser. No. 12/400,668, filed Mar. 9, 2009 and assigned to the same assignee as this invention and hereby incorporated herein by reference, the other color LEDs are also illuminated to some extent simultaneously with the LED of the color whose data is being displayed, to increase the brightness of the image. Accordingly, during green data display, the RED LED remains lighted with a drive current of 1037 (Rg6, the 7^{th} value in Group 6 in FIG. 6). Similarly, the BLUE LED remains lighted with a drive current of 996 (Rb3, the 4th value in FIG. 6).

In sum, during the red data period, as shown in FIG. 7, the red LED current is 2264/4095 (Rr0) of the maximum current, the green LED current is 1663/4095((Gr8) of the maximum current and the blue LED current is 506/4095 (Br8) of the maximum current.

The LED drive controllers in FIGS. 3 and 4 and the drive current table and wave forms in FIGS. 6 and 7 correspond according to the following relationships:

D_{R0}=Rr0,D_{R1}=Rg6,D_{R2}=Rb3,

D_{G0}=Gr4,D_{G1}=Gg1,D_{G2}=Gb7, and

D_{B0}=Br8,D_{B1}=Bg5,D_{B2}=Bb2

As was described earlier, referring to FIG. 5, a decision was made to establish a threshold saturation of 102, and to cut off pixel components above Group 6. Therefore, at this stage, to avoid a “washed out” image, overall saturation must be re-increased up to a compensated saturation value on the projected screen. In the earlier example (R=250, G=200, and B=150), after the cutoff and compensation, the threshold SatVal for Group 6 was 102, as shown in FIG. 5, MinVal and MdlVal become the new minimum and middle values. The MaxVal remains the same as the prior values for R, at 250.

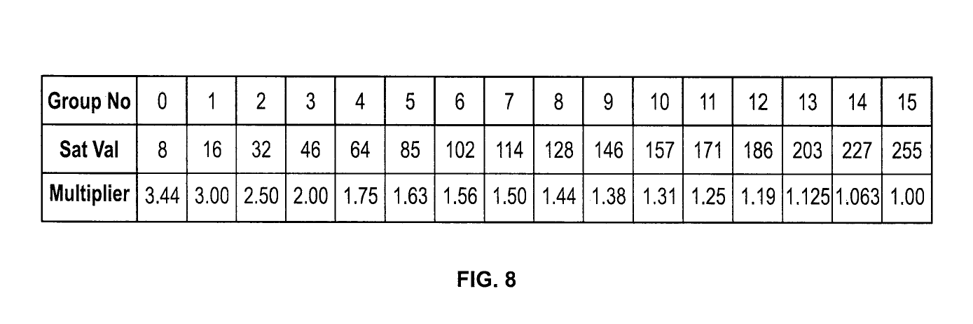

FIG. 8 is a table of empirically determined multiplier values for each group shown in FIG. 5. These values were determined by looking at many images and determining what multipliers caused the most pleasing results. From the table in FIG. 8, for Group 6 used in our example, the multiplier is 1.56. This multiplier is used to determine a new, boosted saturation value (NewMax, NewMin and NewMdl) for each of the colored pixels, as follows.

NewMax=MaxVal(the most saturated pixel, R, doesn't change)

NewMin=MinVal−[(MaxVal−MinVal)*(Multiplier−1)]

NewMdl=[(MdlVal−MinVal)*Multiplier]+NewMin

### Therefore,

NewMax=MaxVal=250

NewMin=150−(250−150)*(1.56−1)=150−[(100)*0.56]=150−56=94

NewMdl=[(200−150)*(1.56)]+94=[50*1.56]+94=78+94=172

Referring to FIG. 2, these calculations are made in saturation compensator 240, and the resulting new saturation values NewMax, NewMin and NewMdl are passed from saturation compensator 240 through selector 250 to frame sequencer 40 and display device 50 (FIG. 1) for display.

The above saturation boosting is executed in RGB color space, as an example. Other color spaces (YIQ, YUV, or YCrCb) and color components can be applied to accomplish saturation boosting using different equations That may be determined by one of ordinary skill in the art.

A number of embodiments of the invention have been described. Nevertheless, it will be understood that various modifications may be made without departing from the spirit and scope of the invention. Accordingly, other embodiments are within the scope of the following claims.

What is claimed is:

1. A method for improving brightness of projected images from an LED projector employing a plurality of LEDs of different colors, comprising:
determining, from a histogram of a frame of an image to be projected, an effective maximum saturation;
creating a plurality of main channels and a plurality of subchannels, one main channel and at least one subchannel for each color LED;
determining the amplitude of the main channel and a subchannel for each color based upon an effective maximum saturation of the frame of the image; and
using the main channel for a color and the at least one subchannel for the color to drive an LED of the color to generate the image.

2. The method of claim 1 wherein the effective maximum saturation is determined from a plurality of saturation values for the colors making up each pixel of the frame of pixels.

3. The method of claim 2 wherein each of the plurality of saturation values is calculated by subtracting the component value of a color making up a pixel that has the smallest component value of the colors making up the pixel from the component value of a color making up the pixel that has the largest component value of the colors making up the pixel.

4. The method of claim 2 wherein the plurality of saturation values are grouped, a threshold saturation value is determined, and pixels are truncated that fall above the threshold.

5. The method of claim 4 further comprising the step of boosting the saturation values of pixels having saturation values below an effective maximum saturation value.

6. The method of claim 5 wherein the saturation values of the pixels are boosted by an empirically determined amount.

7. The method of claim 6 wherein the empirically determined amount is determined based upon testing many images and determining the amount of boost that gives the best results.

8. The method of claim 6 wherein each of the colors making up a pixel are boosted.

9. A method for improving brightness of projected images from an LED projector employing a plurality of LEDs of different colors, comprising:
determining, from a frame of an image to be projected an effective maximum saturation of a pixel from saturation values of each of the pixel's color components;
grouping the saturation values of the pixels of a frame according to the number of pixels having saturation values within a range of saturation values determined for the group;
establishing a threshold saturation value;
boosting the saturation values of pixels having saturation values below their effective maximum saturation value by an empirically determined multiple to derive overlapped currents used to drive an LED of that color, thereby reducing washout; and
using the boosted pixel saturation values for each color to generate the image.

10. The method of claim 9 wherein a boosted saturation value is calculated by subtracting a component value of a color making up a pixel that has the smallest component value of the colors making up the pixel from the component value of a color making up the pixel that has the largest component value of the colors making up the pixel.

11. The method of claim 10 wherein the empirically determined amount is determined based upon testing many images and determining the amount of boost that gives the best results.
